(19) United States
(12) Patent Application Publication
(10) Pub. No.: US 2025/0023165 A1
(43) Pub. Date: Jan. 16, 2025

(54) BATTERY CELL AND PREPARATION METHOD THEREOF, AND BATTERY

(71) Applicant: ZHUHAI COSMX BATTERY CO., LTD., Zhuhai (CN)

(72) Inventors: Hanli SUN, Zhuhai (CN); Yu XIANG, Zhuhai (CN); Donghui SHENG, Zhuhai (CN); Jichun XIE, Zhuhai (CN)

(73) Assignee: ZHUHAI COSMX BATTERY CO., LTD., Zhuhai (CN)

(21) Appl. No.: 18/900,831

(22) Filed: Sep. 29, 2024

Related U.S. Application Data
(63) Continuation of application No. PCT/CN2023/115457, filed on Aug. 29, 2023.

(30) Foreign Application Priority Data
Oct. 31, 2022 (CN) 202222884930.0

(51) Int. Cl. H01M 50/184; H01M 50/105; H01M 50/178; H01M 50/186

(52) U.S. Cl. CPC H01M 50/184; H01M 50/105; H01M 50/178; H01M 50/186

(57) ABSTRACT

A battery cell includes a battery cell body including a tab and a packaging body including a first sealing adhesive layer, the first sealing adhesive layer includes first and second sealing regions, and along a direction from the battery cell body to the tab, a size of a cross section of the first sealing region is greater than a size of a cross section of the second sealing region. In the battery cell, a structure of a sealing adhesive layer is improved, which improves an adhesion strength and a peeling force between a tab and a packaging body, so as to improve a packaging strength at a tab, thereby improving a packaging quality of a battery cell, and thus ensuring an effective safety service life of a battery, and solving a problem of a failure of a battery cell caused by inadequate sealing at a tab of a battery cell.

### CROSS-REFERENCE TO RELATED APPLICATIONS

This application is a continuation of International Application No. PCT/CN2023/115457, filed on Aug. 29, 2023, which claims priority to Chinese Patent Application No. 202222884930.0 filed on Oct. 31, 2022. Both of the aforementioned applications are hereby incorporated by reference in their entireties.

### TECHNICAL FIELD

The present disclosure relates to the field of battery technologies, and in particular, to a battery cell and a preparation method thereof, and a battery.

### BACKGROUND

When a pouch package, such as an aluminum laminated film, is used to package a battery cell, two aluminum laminated films are thermally fused to form a rectangular sealing adhesive layer, so as to seal the battery cell. However, a packaging at a tab is often not tight, which becomes a potential failure source of liquid leakage of a battery, thereby causing a failure of a battery cell, and thus affecting a normal usage of a battery, reducing an effective life of a battery, and even triggering a safety issue of electricity usage.

### SUMMARY

In view of this, embodiments of the present disclosure are directed to providing a battery cell and a preparation method thereof, and a battery, so that a structure of a sealing adhesive layer on a pouch package is improved, which improves an adhesion strength and a peeling force between a tab and a pouch package, so as to improve a packaging strength at a tab, thereby improving a packaging quality of a battery, and thus solving a problem in that a tab of a battery cell is prone to not being packaged tightly in the related technologies.

An aspect of the present disclosure provides a battery cell, which includes a battery cell body and a packaging body configured to package the battery cell body, and the battery cell body includes a tab; and the packaging body includes a first sealing adhesive layer configured to package the battery cell body, the first sealing adhesive layer includes a first sealing region configured to seal the tab and a second sealing region located on two sides of the first sealing region, and along a direction from the battery cell body to the tab, a size of a cross section of the first sealing region is greater than a size of a cross section of the second sealing region.

In a possible implementation, the cross section of the first sealing region includes a central block, a first protruding block and a second protruding block along the direction from the battery cell body to the tab, the first protruding block is formed by protruding outwardly from a side of the central block, and the second protruding block is formed by protruding outwardly from another side of the central block.

In a possible implementation, a side of the first protruding block is connected to the central block, and another side of the first protruding block is a first arc edge.

In a possible implementation, a side of the second protruding block is connected to the central block, and another side of the second protruding block is a second arc edge.

In a possible implementation, along the direction from the battery cell body to the tab, a size of the first protruding block ranges from 0.5 mm to 5 mm; and/or along the direction from the battery cell body to the tab, a size of the second protruding block ranges from 0.5 mm to 5 mm.

In a possible implementation, a degree of a central angle of an arc edge of the first protruding block is not greater than 90 degrees; and/or a degree of a central angle of an arc edge of the second protruding block is not greater than 90 degrees.

In a possible implementation, a radius of an arc edge of the first protruding block ranges from 2 mm to 20 mm; and/or a radius of an arc edge of the second protruding block ranges from 2 mm to 20 mm.

In a possible implementation, along the direction from the battery cell body to the tab, a size of the central block is equal to a size of the second sealing region.

In a possible implementation, along a first direction perpendicular to the direction from the battery cell body to the tab, an edge of a side of the first sealing region exceeds beyond an edge of a same side of the tab by a distance of 1 mm to 20 mm; and/or along a first direction perpendicular to the direction from the battery cell body to the tab, an edge of another side of the first sealing region exceeds beyond an edge of a same side of the tab by a distance of 1 mm to 20 mm.

In a possible implementation, a size, along a second direction perpendicular to the direction from the battery cell body to the tab, of the second sealing region gradually decreases along a direction from being away from the tab to being close to the tab.

In a possible implementation, a difference between a maximum size of the second sealing region and a minimum size of the second sealing region is not greater than 50 μm.

In a possible implementation, along the direction from being close to the tab to being away from the tab, the second sealing region includes a first portion and a second portion, and along the second direction perpendicular to the direction from the battery cell body to the tab, a size of the second portion is less than a size of the first portion, and the size of the first portion is not greater than 1 mm.

In a possible implementation, a difference between a maximum size of the first portion and a minimum size of the first portion is not greater than 10 μm.

In a possible implementation, a peeling force of the first sealing region is greater than a peeling force of the second sealing region.

In a possible implementation, a peeling force of the first sealing region and a peeling force of the second sealing region are both greater than 2 N/mm.

In a possible implementation, a peeling force of the first sealing region ranges from 4 N/mm to 6 N/mm.

In a possible implementation, along a first direction perpendicular to the direction from the batter cell body to the tab, a size of the first sealing region is greater than or equal to a size of the tab.

In a possible implementation, the size, along the direction from the battery cell body to the tab, of the cross section of the first sealing region gradually decreases from a center of the tab towards a side of the tab, and the size, along the direction from the battery cell body to the tab, of the cross section of the first sealing region gradually decreases from the center of the tab towards another side of the tab.

The present disclosure further provides a method for preparing a battery cell, which includes: S410: providing an electromagnetic induction coil on a side, on which a tab of the battery cell is located, of a packaging body of the battery cell; S420: heating the packaging body at the side on which the tab is located by using the electromagnetic induction coil, so that a heat sealing layer of the packaging body and a thermal-fusion bonding member on the tab are thermally fused at a first thermal-fusion position, and the heat sealing layer of the packaging body is thermally fused at a second thermal-fusion position; and S430: extruding the packaging body thermally fused and the tab thermally fused by using a sealing head to form a first sealing adhesive layer on the side, on which the tab is located, of the packaging body, where the first sealing adhesive layer includes a first sealing region located at the first thermal-fusion position and configured to seal the tab, and a second sealing region located at the second thermal-fusion position, the second sealing region is located on two sides of the first sealing region, and along a direction from a battery cell body of the battery cell to the tab, a size of a cross section of the first sealing region is greater than a size of a cross section of the second sealing region.

The present disclosure further provides a battery, which includes the battery cell described above.

In the battery cell of the present disclosure, the battery cell body is packaged by the first sealing adhesive layer at its side provided with the tab, the first sealing adhesive layer is divided into the first sealing region for sealing the tab and the second sealing region located on the two sides of the first sealing region, and along the direction from the battery cell body to the tab, the size of the cross section of the first sealing region is greater than the size of the cross section of the second sealing region. A sealing area at the tab is increased, which enhances an adhesion strength and an adhesion area between a packaging body and a tab, so as to improve a packaging reliability, thereby significantly reducing or completely avoiding a problem of virtual sealing. Additionally, an adhesion strength and a peeling force between the tab and the packaging body are improved, so that a packaging strength at a tab is improved, thereby improving a packaging quality of a battery cell, and thus ensuring an effective safety service life of a battery and avoiding a failure of a battery cell.

### BRIEF DESCRIPTION OF THE DRAWINGS

FIG. 1 is a schematic structural diagram of a cross section of a battery cell according to an embodiment of the present disclosure.

FIG. 2 is a schematic structural diagram of a cross section of a first sealing region according to an embodiment of the present disclosure.

FIG. 3 is a schematic structural diagram of an electromagnetic induction coil and a packaging body.

FIG. 4 is a schematic flowchart of a method for preparing a battery cell according to an embodiment of the present disclosure.

### DETAILED DESCRIPTION OF THE EMBODIMENTS

The following clearly and completely describes the technical solutions in the embodiments of the present disclosure with reference to the accompanying drawings in the embodiments of the present disclosure. Obviously, the embodiments described are only a part of the embodiments of the present disclosure, not all the embodiments. All other embodiments obtained by a person of ordinary skill in the art based on the embodiments of the present disclosure without creative efforts shall fall within the protection scope of the present disclosure.

Due to a fact that a top end of a tab of a battery cell needs to extend beyond an aluminum laminated film, a phenomenon that a packaging of the tab is not tight often occurs. For example, there is a virtual sealing region where the tab is not adhered to a sealing adhesive layer or where an adhesion strength between the tab and a sealing adhesive layer is weak, which becomes a potential failure source of liquid leakage of a battery, thereby causing a failure of a battery cell, and thus affecting a normal usage of a battery, reducing an effective life of a battery, and even triggering a safety issue of electricity usage.

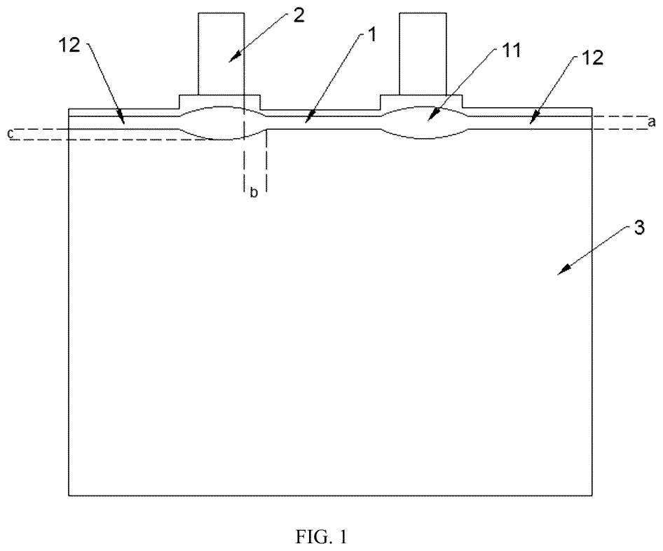

Referring to FIG. 1 to FIG. 3, embodiments of the present disclosure provide a battery cell, which includes a battery cell body and a packaging body 3, the battery cell body includes two tabs 2, and the two tabs 2 are respectively a positive tab and a negative tab. The battery cell body is wrapped and packaged by the packaging body 3, and the packaging body 3 is usually a pouch package, for example, an aluminum laminated film or an aluminum laminated shell. The packaging body 3 is provided with a first sealing adhesive layer 1, and the first sealing adhesive layer 1 is a sealing adhesive layer sealing a side, provided with the tabs 2, of the battery cell body, i.e., the packaging body 3 is provided with the first sealing adhesive layer 1 packaging a side, on which the tabs 2 are located, of the battery cell body. Of course, a second sealing adhesive layer, a third sealing adhesive layer, and the like for packaging other sides of the battery cell body may also be formed on the packaging body 3.

The battery cell body is sealed by the first sealing adhesive layer 1 at its side provided with the tabs 2, and in order to solve a problem of inadequate sealing at a tab, in this embodiment, along an arrangement direction of the tabs 2, i.e., along a first direction perpendicular to a direction from the battery cell body to the tab 2, the first sealing adhesive layer 1 is divided into a first sealing region 11 for sealing the tab 2 and a second sealing region 12 located on two sides of the first sealing region 11. As an example in FIG. 1, there are two first sealing regions 11, and there are three second sealing regions 12. At least a portion of a sealing adhesive layer in the first sealing region 11 is adhered to the tab 2, so as to seal the tab 2. In some embodiments, a size (a length) of the first sealing region 11 is not less than a size (a width) of the tab 2 along the arrangement direction of the tabs 2, and the arrangement direction of the tabs 2 is the first direction perpendicular to the direction from the battery cell body to the tab 2, which is the same as a length direction of the first sealing adhesive layer 1 and is also the same as a width direction of the tab 2. Along the direction from the battery cell body to the tab 2, a size (a width) of a sealing cross section (i.e., a cross section) of the first sealing region 11 is greater than a size (a width) of a cross section of the second sealing region 12. The cross section refers to a cross section along a length direction or width direction of the battery cell body (a direction from a side of the tab 2 to another side, opposite to that side, of the tab 2).

In the battery cell of the present disclosure, the width of the first sealing region 11 is increased on a basis of ensuring a length of the first sealing region 11, so that a sealing area at the tab 2 is increased to enhance an adhesion strength and an adhesion area between the packaging body 3 and the tab 2, thereby improving a packaging strength at the tab 2, so as to ensure that a packaging at the tab 2 is tight and secure, and thus significantly reducing or completely avoiding a problem of virtual sealing, and effectively avoiding a risk that a sealing region at the tab 2 is extremely prone to fracture when the battery cell undergoes gas generation, collision or dropping. An adhesion strength and a peeling force between the tab 2 and the packaging body 3 are improved (the peeling force refers to a force required to separate the tab 2 from the packaging body 3, and the greater the adhesion strength, the greater the peeling force, and the greater the peeling strength), which improves an overall reliability of a packaging of a battery cell and a packaging quality of a battery cell, and solves potential risk factors leading to a failure of a battery cell due to inadequate sealing, thereby more effectively ensuring a safe usage of a battery cell and ensuring an effective safety service life of a battery cell. Such an arrangement ensures that a battery cell with this packaging structure has stable performance and high safety.

The cross section of the second sealing region 12 is strip-shaped, and in an embodiment, the cross section of the first sealing region 11 may be divided into a central block, a first protruding block, and a second protruding block. Along the direction from the battery cell body to the tab 2, a size (a width) of the central block is consistent with a size (a width) of the second sealing region 12, the first protruding block is located on a side, along a width direction of the central block, of the central block, the second protruding block is located on another side, along the width direction of the central block, of the central block, the first protruding block is formed by protruding outwardly from a side of the central block, the second protruding block is formed by protruding outwardly from another side of the central block, and the width direction of the central block is the direction from the battery cell body to the tab 2. Compared with the second sealing region 12, a sealing adhesive layer of the first sealing region 11 has widened blocks that protrude in both a direction close to the tab 2 and a direction close to a bottom of the battery cell body, which not only makes the width of the cross section of the first sealing region 11 greater than the width of the cross section of the second sealing region 12, but also enlarges a sealing area of the first sealing region 11 on a basis of maintaining one-time molding of the first sealing adhesive layer 1 (i.e., on a basis of not increasing complexity of a molding process and a cost). In addition, the first sealing region 11 is enlarged on both an upper side and a lower side along a width direction of the first sealing region 11, and an enlarged area is an effective sealing area for adhering to the tab 2, so that an adhesion area and an adhesion strength between the packaging body 3 and the tab 2 can be significantly enhanced, so as to ensure a tight and secure packaging.

Of course, in other embodiments, compared with the second sealing region 12, the first sealing region 11 may also have a protruding block only on one side, along the width direction of the central block, of the central block, so that the width of the cross section of the first sealing region 11 is greater than the width of the cross section of the second sealing region 12.

In an embodiment, a side of the first protruding block is connected to the central block, another side of the first protruding block is a first arc edge, and both ends, along a length direction of the first arc edge (i.e., the first direction perpendicular to the direction from the battery cell body to the tab 2), of the first arc edge may extend to connect to the central block, i.e., the first protruding block is enclosed by the first arc edge and a side edge that is in contact with and connected to the central block. The first arc edge forms a side edge, along a width direction of the first sealing region 11 (i.e., the direction from the battery cell body to the tab 2), of the first sealing region 11.

In some embodiments, a side of the second protruding block is connected to the central block, another side of the second protruding block is a second arc edge, and both ends, along a length direction of the second arc edge, of the second arc edge may extend to connect to the central block, i.e., the second protruding block is enclosed by the second arc edge and a side edge that is in contact with and connected to the central block. The second arc edge forms another side edge, along a width direction of the first sealing region 11 (i.e., the direction from the battery cell body to the tab 2), of the first sealing region 11.

When both the first protruding block and the second protruding block have an arc edge, two side edges, along the width direction of the first sealing region 11 (i.e., the direction from the battery cell body to the tab 2), of the first sealing region 11 are formed by two arc edges (i.e., the first arc edge and the second arc edge).

Such an arrangement ensures that along the direction from the battery cell body to the tab 2, a size (a width) of the cross section of the first sealing region 11 is the greatest at a center or a center line, along a width direction of the tab 2 (the first direction perpendicular to the direction from the battery cell body to the tab 2), of the tab 2, the size (the width) of the cross section of the first sealing region 11 gradually decreases from the center line of the tab 2 towards a side of the tab 2, the size (the width) of the cross section of the first sealing region 11 gradually decreases from the center line of the tab 2 towards another side of the tab 2, and contour edges of two sides, along the width direction of the first sealing region 11, of the first sealing region 11 are arc edges. Such an arrangement, on the one hand, ensures that there are no abrupt changes or sharp corners at a junction between the first sealing region 11 and the second sealing region 12, which reduces an edge stress of a sealing adhesive layer and enhances a sealing strength is to a certain extent; and such an arrangement, on the other hand, on a basis of ensuring a sealing area and a sealing strength, avoids occupying unnecessary space due to excessive area, thereby preventing a reduction in an energy density of a battery.

In an embodiment shown in FIG. 1, a shape of the cross section of the second sealing region 12 is a first rectangle, and a shape of the first sealing region 11 includes a second rectangle, a first arch and a second arch, i.e., a sealing cross section of the first sealing region 11 includes three blocks with the shapes of the second rectangle, the first arch and the second arch, and an overall shape of the sealing cross section is approximately elliptical. The second rectangle is equivalent to the central block and has equivalent width with the first rectangle, the first arch is located on a side, along a width direction of the second rectangle (the direction from the battery cell body to the tab 2), of the second rectangle, the first arch is equivalent to the first protruding block, the second arch is located on another side, along the width direction of the second rectangle, of the second rectangle, and the second arch is equivalent to the second protruding block.

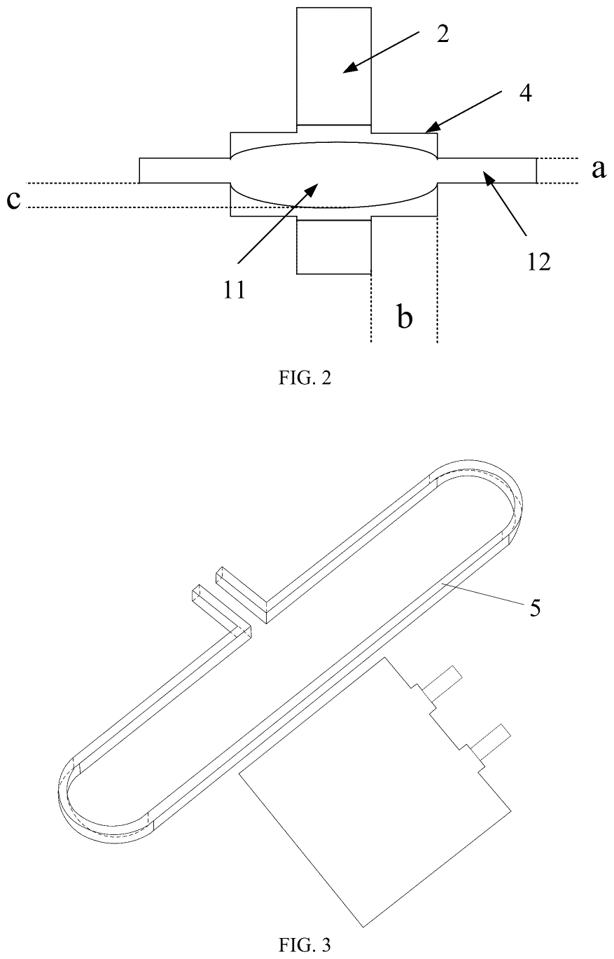

As shown in FIG. 2, the width of the cross section of the second sealing region 12 is same as the width of the cross section of the central block of the first sealing region 11, a value of the width is denoted as a, and a specific value is determined according to parameters of a battery cell. The length of the first sealing region 11 is greater than the width of the tab 2, and along the length direction of the first sealing adhesive layer 1 (the first direction perpendicular to the direction from the battery cell body to the tab 2), a distance by which an edge of a side of the first sealing region 11 exceeds beyond an edge of a same side of the tab 2 is b, and a value of b may range from 1 mm to 20 mm (millimeter), for example, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, and the like. Similarly, a distance by which an edge of another side of the first sealing region 11 exceeds beyond an edge of a same side of the tab 2 ranges from 1 mm to 20 mm, for example, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, and the like.

A length of a straight edge of the first protruding block and a length of a straight edge of the second protruding block (a corresponding arch includes an arch edge and a straight edge) may be consistent with or different from a length of a long side of the second rectangle.

Widths of the first protruding block and the second protruding block are denoted as c, and the width of the first protruding block may be consistent with or different from the width of the second protruding block. The width of the first protruding block ranges from 0.5 mm to 5 mm, for example, 0.5 mm, 1 mm, 1.5 mm, 2 mm, 2.5 mm, 3 mm, 3.5 mm, 4 mm, 4.5 mm, 5 mm, and the like. The width of the second protruding block ranges from 0.5 mm to 5 mm, for example, 0.5 mm, 1 mm, 1.5 mm, 2 mm, 2.5 mm, 3 mm, 3.5 mm, 4 mm, 4.5 mm, 5 mm, and the like.

A degree of a central angle of an arc edge of the first protruding block is not greater than 90 degrees, for example, 30 degrees, 45 degrees, 50 degrees, 60 degrees, 65 degrees, 70 degrees, 75 degrees, 80 degrees, 85 degrees, 86 degrees, 88 degrees, 90 degrees, and the like. A degree of a central angle of an arc edge of the second protruding block is not greater than 90 degrees, for example, 30 degrees, 45 degrees, 50 degrees, 60 degrees, 65 degrees, 70 degrees, 75 degrees, 80 degrees, 85 degrees, 86 degrees, 88 degrees, 90 degrees, and the like.

A radius of an arc edge of the first protruding block ranges from 2 mm to 20 mm, for example, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, and the like. A radius of an arc edge of the second protruding block ranges from 2 mm to 20 mm, for example, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, and the like.

In some embodiments, a peeling force of the first sealing region and a peeling force of the second sealing region are both greater than 2 N/mm. In some embodiments, the peeling force of the first sealing region 11 is greater than the peeling force of the second sealing region 12, for example, the peeling force of the first sealing region 11 ranges from 4 N/mm to 6 N/mm, for example, 4.3 N/mm, 4.7 N/mm, 5 N/mm, and 5.4 N/mm. The peeling force refers to a pulling force required for separating the tab 2 from the packaging body 3. The peeling force of the first sealing region 11 refers to a pulling force required for separating the tab 2 from the packaging body 3 within a region range of the first sealing region 11. The peeling force of the second sealing region 12 refers to a pulling force required for separating the tab 2 from the packaging body 3 within a region range of the second sealing region 12

Along a direction from being close to the tab 2 to being away from the tab 2, i.e., a direction from a side where the battery cell body is located to an outer side of the battery cell body, a size, along a second direction perpendicular to the direction from the battery cell body to the tab 2, of the second sealing region 12 gradually decreases, i.e., in a decreasing trend. For example, a difference between a maximum size and a minimum size is not greater than 50 μm (micrometer), for example, 10 μm, 20 μm, 30 μm, 35 μm, 40 μm, 45 μm, and 50 μm.

At a side close to the tab 2, the second sealing region 12 includes a first portion, and a remaining region may be a second portion. Along the second direction perpendicular to the direction from the battery cell body to the tab 2, a size of the first portion is greater than a size of the second portion, and the size of the first portion is not greater than 1 mm.

Within the first portion, the size along the second direction perpendicular to the direction from the battery cell body to the tab 2 also shows a gradual decrease, and a difference between a maximum size and a minimum size is not greater than 10 μm, for example, 3 μm, 5 μm, 8 μm, 10 μm, and the like.

It should be noted that, because an overall structure of a battery cell is a three-dimensional structure, there are two directions perpendicular to the direction from the battery cell body to the tab 2, one is the first direction in the present disclosure, and another is the second direction in the present disclosure. The direction from the battery cell body to the tab 2 may be understood as an up-down direction parallel to a paper plane where the battery cell shown in FIG. 1 is located, the first direction may be understood as a left-right direction parallel to the paper plane where the battery cell shown in FIG. 1 is located, and the second direction may be understood as a front-rear direction perpendicular to the paper plane where the battery cell shown in FIG. 1 is located.

As shown in FIGS. 1 and 2, the packaging body 3 is provided with an aluminum layer and a heat sealing layer, and during packaging, two packaging bodies 3 are oppositely arranged. At a position without the tab 2, two heat sealing layers in the two packaging bodies 3 are opposite to each other. At a position where the tab 2 is located, a thermal-fusion bonding member 4, such as a colloid or polypropylene, is provided on the tab 2, the heat sealing layer is arranged opposite to the thermal-fusion bonding member 4, and the heat sealing layer and the thermal-fusion bonding member 4 form the first sealing adhesive layer 1 through heat sealing. The first sealing region 11 is formed by thermally fusing the heat sealing layer and the thermal-fusion bonding member 4, and the second sealing region 12 is formed by thermally fusing the two heat sealing layers. An entire sealing adhesive layer is formed by collosol.

In specific production, as shown in FIG. 3, the first sealing adhesive layer 1 may be formed by heating with an electromagnetic induction coil 5 and extruding with a sealing head. For example, a packaging assembly is used to process the packaging body 3 to form the first sealing adhesive layer 1 in the above embodiments.

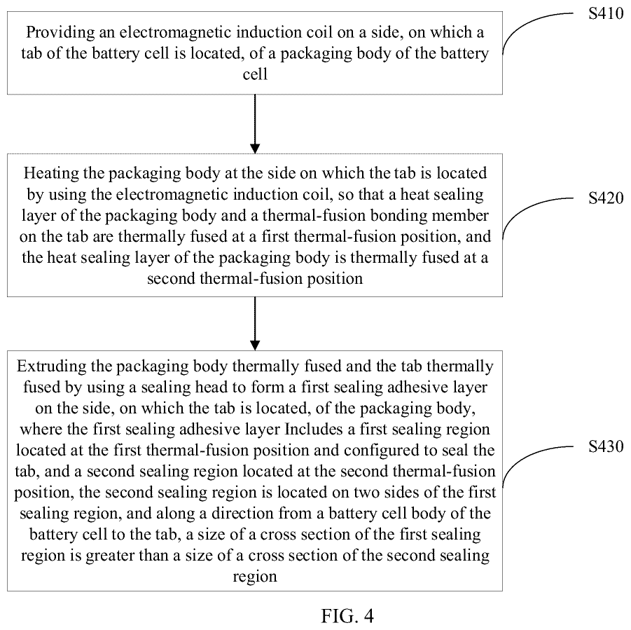

In an embodiment, as shown in FIG. 4, the method for preparing the battery cell includes: S410: providing an electromagnetic induction coil on a side, on which a tab of the battery cell is located, of a packaging body of the battery cell; S420: heating the packaging body at the side on which the tab is located by using the electromagnetic induction coil, so that a heat sealing layer of the packaging body and a thermal-fusion bonding member on the tab are thermally fused at a first thermal-fusion position, and the heat sealing layer of the packaging body is thermally fused at a second thermal-fusion position; and S430: extruding the packaging body thermally fused and the tab thermally fused by using a sealing head to form a first sealing adhesive layer on the side, on which the tab is located, of the packaging body, where the first sealing adhesive layer includes a first sealing region located at the first thermal-fusion position and configured to seal the tab, and a second sealing region located at the second thermal-fusion position, the second sealing region is located on two sides of the first sealing region, and along a direction from a battery cell body of the battery cell to the tab, a size of a cross section of the first sealing region is greater than a size of a cross section of the second sealing region.

The packaging body 3 has a metal layer (such as an aluminum layer) and a heat sealing layer, and the packaging assembly includes the electromagnetic induction coil 5 for heating the packaging body 3 and the sealing head for extruding the packaging body 3. A specific process is as follows. The packaging body 3 is placed close to the electromagnetic induction coil 5 and is located outside the electromagnetic induction coil 5, and a distance from a top end (an end close to the tab 2) of the packaging body 3 to the coil may range from 1 mm to 2 mm. After the electromagnetic induction coil 5 is energized with an alternating current, the high-frequency alternating current in the electromagnetic induction coil 5 generates a high-frequency change magnetic field, the magnetic field acts on the packaging body 3 and the tab 2 outside the electromagnetic induction coil 5, and an inducing eddy current is generated in the tab 2 and the metal layer of the packaging body 3, so that the metal layer and the tab 2 generate heat. The metal layer and the tab 2 transfer the heat to the heat sealing layer and the thermal-fusion bonding member 4 at the tab 2, so that the heat sealing layer and the thermal-fusion bonding member 4 are thermally fused, and the thermally fusing region is extruded by the sealing head, so that the heat sealing layer and the thermal-fusion bonding member 4 are fused, so as to form the first sealing adhesive layer 1, thereby completing the packaging.

The packaging assembly is adopted for processing, so that the first sealing adhesive layer 1 can be conveniently and efficiently obtained, and a packaging strength at the tab 2 is improved, so as to improve a packaging reliability, thereby solving a problem of a failure of a battery cell caused by a risk of liquid leakage due to inadequate sealing, and thus ensuring usage safety and a usage quality of a battery.

The embodiments of the present disclosure further provide a battery, which includes the battery cell described in any one of the above embodiments, and the battery provided in the embodiments is tightly and securely packaged, has high safety, and can be effectively used for a long time, thereby solving a potential risk of a failure of a battery cell caused by inadequate sealing at the tab 2. A derivation process of the beneficial effects is basically consistent with a derivation process of the beneficial effects of the battery cell, and details are not described herein again.

The basic principles of the present disclosure are described above with reference to the specific embodiments, but it should be noted that the advantages, the benefits, the effects, and the like mentioned in the present disclosure are merely exemplary rather than limiting, and it should not be assumed that these advantages, benefits, effects, and the like are essential for every embodiment of the present disclosure. In addition, the specific details disclosed above are only for illustrative and comprehension purposes, not for limiting purposes, and the above-mentioned details are not intended to limit the present disclosure to be implemented by using the specific details above.

The components or the apparatuses involved in the present disclosure are merely provided as illustrative examples and are not intended to require or imply that the components or the apparatuses must be connected, arranged, or configured shown in the accompanying drawings. As will be appreciated by a person skilled in the art, the components or the apparatuses may be connected, arranged, or configured in any manner. The terms such as “including”, “containing”, “having”, and the like are open-ended terms that mean “including but not limited to”, which may be interchanged with each other. The terms “or” and “and” used herein refer to the term “and/or”, which may be interchanged with each other, unless the context clearly dictates otherwise. The term “such as” used herein refers to the phrase “such as, but not limited to”, which may be interchanged with each other.

It should also be noted that, in the apparatus or the device of the present disclosure, the components may be decomposed and/or recombined. Such decomposition and/or recombination should be considered as equivalent solutions of the present disclosure.

The above descriptions of the disclosed aspects are provided to enable any person skilled in the art to make or use the present disclosure. Various modifications to these aspects will be readily apparent to a person skilled in the art, and the generic principles defined herein may be applied to other aspects without departing from the scope of the present disclosure. Thus, the present disclosure is not intended to be limited to the aspects shown herein, but is to be accorded the broadest scope consistent with the principles and novel features disclosed herein.

It should be understood that the terms “first” and “second” used in the description of the embodiments of the present disclosure are merely used to describe the technical solutions more clearly, and cannot be used to limit the protection scope of the present disclosure.

The above descriptions have been presented for purposes of illustration and description. Moreover, such descriptions are not intended to limit the embodiments of the present disclosure to the forms disclosed herein. While various example aspects and embodiments have been discussed above, a person skilled in the art will recognize certain variations, modifications, changes, additions, and sub-combinations thereof.

The above are only preferred embodiments of the present disclosure and are not intended to limit the present disclosure, and any modification, equivalent replacement, etc. made within the spirit and the principles of the present disclosure shall fall within the protection scope of the present disclosure.

What is claimed is:

1. A battery cell, comprising a battery cell body and a packaging body configured to package the battery cell body, wherein
the battery cell body comprises a tab, the packaging body comprises a first sealing adhesive layer configured to package the battery cell body, the first sealing adhesive layer comprises a first sealing region configured to seal the tab and a second sealing region located on two sides of the first sealing region, and along a direction from the battery cell body to the tab, a size of a cross section of the first sealing region is greater than a size of a cross section of the second sealing region.

2. The battery cell according to claim 1, wherein the cross section of the first sealing region comprises a central block, a first protruding block and a second protruding block along the direction from the battery cell body to the tab, the first protruding block is formed by protruding outwardly from a side of the central block, and the second protruding block is formed by protruding outwardly from another side of the central block.

3. The battery cell according to claim 2, wherein a side of the first protruding block is connected to the central block, and another side of the first protruding block is a first arc edge.

4. The battery cell according to claim 2, wherein a side of the second protruding block is connected to the central block, and another side of the second protruding block is a second arc edge.

5. The battery cell according to claim 2, wherein along the direction from the battery cell body to the tab, a size of the first protruding block ranges from 0.5 mm to 5 mm; and/or
along the direction from the battery cell body to the tab, a size of the second protruding block ranges from 0.5 mm to 5 mm.

6. The battery cell according to claim 2, wherein a degree of a central angle of an arc edge of the first protruding block is not greater than 90 degrees; and/or
a degree of a central angle of an arc edge of the second protruding block is not greater than 90 degrees.

7. The battery cell according to claim 2, wherein a radius of an arc edge of the first protruding block ranges from 2 mm to 20 mm; and/or
a radius of an arc edge of the second protruding block ranges from 2 mm to 20 mm.

8. The battery cell according to claim 2, wherein along the direction from the battery cell body to the tab, a size of the central block is equal to a size of the second sealing region.

9. The battery cell according to claim 1, wherein along a first direction perpendicular to the direction from the battery cell body to the tab, an edge of a side of the first sealing region exceeds beyond an edge of a same side of the tab by a distance of 1 mm to 20 mm; and/or
along the first direction perpendicular to the direction from the battery cell body to the tab, an edge of another side of the first sealing region exceeds beyond an edge of a same side of the tab by a distance of 1 mm to 20 mm.

10. The battery cell according to claim 1, wherein a size, along a second direction perpendicular to the direction from the battery cell body to the tab, of the second sealing region gradually decreases along a direction from being away from the tab to being close to the tab.

11. The battery cell according to claim 10, wherein a difference between a maximum size of the second sealing region and a minimum size of the second sealing region is not greater than 50 μm.

12. The battery cell according to claim 10, wherein along the direction from being close to the tab to being away from the tab, the second sealing region comprises a first portion and a second portion, and along the second direction perpendicular to the direction from the battery cell body to the tab, a size of the second portion is less than a size of the first portion, and the size of the first portion is not greater than 1 mm.

13. The battery cell according to claim 12, wherein a difference between a maximum size of the first portion and a minimum size of the first portion is not greater than 10 μm.

14. The battery cell according to claim 1, wherein a peeling force of the first sealing region is greater than a peeling force of the second sealing region.

15. The battery cell according to claim 1, wherein a peeling force of the first sealing region and a peeling force of the second sealing region are both greater than 2 N/mm.

16. The battery cell according to claim 1, wherein a peeling force of the first sealing region ranges from 4 N/mm to 6 N/mm.

17. The battery cell according to claim 1, wherein along a first direction perpendicular to the direction from the batter cell body to the tab, a size of the first sealing region is greater than or equal to a size of the tab.

18. The battery cell according to claim 1, wherein the size, along the direction from the battery cell body to the tab, of the cross section of the first sealing region gradually decreases from a center of the tab towards a side of the tab, and the size, along the direction from the battery cell body to the tab, of the cross section of the first sealing region gradually decreases from the center of the tab towards another side of the tab.

19. A method for preparing a battery cell, comprising:
S410: providing an electromagnetic induction coil on a side, on which a tab of the battery cell is located, of a packaging body of the battery cell;
S420: heating the packaging body at the side on which the tab is located by using the electromagnetic induction coil, so that a heat sealing layer of the packaging body and a thermal-fusion bonding member on the tab are thermally fused at a first thermal-fusion position, and the heat sealing layer of the packaging body is thermally fused at a second thermal-fusion position; and
S430: extruding the packaging body thermally fused and the tab thermally fused by using a sealing head to form a first sealing adhesive layer on the side, on which the tab is located, of the packaging body, wherein the first sealing adhesive layer comprises a first sealing region located at the first thermal-fusion position and configured to seal the tab, and a second sealing region located at the second thermal-fusion position, the second sealing region is located on two sides of the first sealing region, and along a direction from a battery cell body of the battery cell to the tab, a size of a cross section of the first sealing region is greater than a size of a cross section of the second sealing region.

20. A battery, comprising a battery cell body and a packaging body configured to package the battery cell body, wherein the battery cell body comprises a tab, the packaging body comprises a first sealing adhesive layer configured to package the battery cell body, the first sealing adhesive layer comprises a first sealing region configured to seal the tab and a second sealing region located on two sides of the first sealing region, and along a direction from the battery cell body to the tab, a size of a cross section of the first sealing region is greater than a size of a cross section of the second sealing region.
